(19) United States
(12) Patent Application Publication
(10) Pub. No.: US 2008/0302987 A1
(43) Pub. Date: Dec. 11, 2008

(54) IRRIGATION SHUTOFF DEVICE

(76) Inventor: Sylvain C. Corriveau, Punta Gorda, FL (US)

Correspondence Address: EDWARD M. LIVINGSTON, PA, 963 TRAIL TERRACE DRIVE, NAPLES, FL, 34103, US

(21) Appl. No.: 11/761,003

(22) Filed: Jun. 11, 2007

(51) Int. Cl. F16K 43/00

(52) U.S. Cl. 251/129.04; 137/487.5; 137/624.14; 239/69

(57) ABSTRACT

An irrigation shutoff device (1) that is operational with and fluidly connected to a sprinkler (44) or irrigation valve (37) wherein the irrigation shutoff device (1) has a propeller (10), a coil (11), a timing rod (5) and a timing bar (4) located within a housing (26) and at least one switch (12 and 13). The propeller (10) and coil (11) are located on a first end (47) of the timing rod (5) and a dial adjustment timer (6) is located on a second opposite end (48) of the timing rod (5). The timing rod (5) extends through the timing bar (4) and the at least one switch (12 and 13) is located a predetermined distance between the first and second ends (47 and 48) of the timing rod (5). A malfunction indicator (25) provides a visual cue as to when the irrigation shutoff device (1) has been activated, thereby requiring a user to repair the sprinkler system.

### BACKGROUND OF THE INVENTION

This invention relates to irrigation shutoff devices, more particularly, an irrigation shutoff device that prevents over-watering of a ground surface in the event a sprinkler system continues to operate after surpassing an original shutoff time.

Currently, most sprinkler systems operate for a predetermined amount of time as determined by an electric timer. A user simply programs the timer for the sprinkler system to turn on and off, thereby watering a ground surface for a specific amount of time. In addition, the timer also permits a user to program which area of the ground surface, also called a zone, in which to water. The use of a timer is a convenient way in which to water a ground surface as the user may simply select which day, time and duration in which to water a ground surface.

However, in the event of power outages or high or low electrical disturbances due to underground wiring size, distance of underground wiring size, main electrical system breaker problems, overloading the electrical wiring system at any given time, inefficient wiring or a faulty solenoid caused by age and deterioration or electrical disturbances caused by any other circumstance, the timer itself must be reset. If the user is unaware that a power outage or electrical disturbance has occurred, he or she runs the risk of not watering the ground surface or, in the alternative, over-watering the ground surface. In addition, if the sprinkler system utilizes at least one solenoid which is connected to a timer and if the solenoid becomes clogged with sand or other debris, the timer will not turn off at the sprinkler system at the original shutoff time, thereby causing over-watering of the ground surface. As a result, the over-watering destroys the ground surface, thereby costing the owner of the ground surface money for replacement of the ground surface and, in the case of a fairway or green on a golf course, result in additional fines for the owner.

Thus, a need exists for an irrigation shutoff device that will prevent over-watering of a ground surface in the event a sprinkler system continues to operate after surpassing an original shutoff time.

The relevant prior art includes the following references:

| U.S. Pat. No. | | |
|---|---|---|
| (U.S. unless stated otherwise) | Inventor | Issue/Publication Date |
| 3,894,690 | Hill | Jul. 15, 1975 |
| 4,593,858 | Pacht | Jun. 10, 1986 |
| 4,662,563 | Wolfe, Jr. | May 5. 1987 |
| 4,693,419 | Weintraub et al. | Sep. 15, 1987 |
| 6,283,139 | Symonds et al. | Sep. 4, 2001 |
| 7,010,394 | Runge et al. | Mar. 7, 2006 |
| 2005/0217737 | Arigoni | Oct. 6, 2005 |
| GB 2 177 582 | Kitching | Jan. 27, 1987 |

### SUMMARY OF THE INVENTION

The primary object of the present invention is to provide an irrigation shutoff device that will prevent over-watering of a ground surface in the event a sprinkler system continues to operate after surpassing an original shutoff time.

Another object of the present invention is to provide an irrigation shutoff device that functions independently of a timer or solenoid.

A further object of the present invention is to provide an irrigation shutoff device that is easy to use.

An even further object of the present invention is to provide an irrigation shutoff device that may be used for commercial and residential sprinkler systems.

Another object of the present invention is to provide an irrigation shutoff device that may be used in conjunction with an irrigation valve.

The present invention fulfills the above and other objects by providing an irrigation shutoff device that is operational with and fluidly connected to a sprinkler or irrigation valve wherein the irrigation shutoff device has a propeller, coil, a timing rod and a timing bar located within a housing and at least one switch. The propeller and coil are located on a first end of the timing rod and a dial adjustment timer is located on a second opposite end of the timing rod. The timing rod extends through the timing bar and the at least one switch is located a predetermined distance between the first and second ends of the timing rod. A malfunction indicator provides a visual cue as to when the irrigation shutoff device has been activated, thereby requiring a user to repair the sprinkler system.

The irrigation shutoff device of the present invention is connected to the sprinkler or irrigation valve in such a manner as to provide water flow through the irrigation shutoff device wherein the propeller is rotated. A user first adjusts the dial adjustment timer to a desired backup shutoff time that is greater than the original shutoff time set on the timer. When the sprinkler system is running, the propeller is rotated, thereby moving the timing bar moves towards the at least one switch. If the sprinkler system if operating properly, the timing bar will move a predetermined distance along the timing rod and stop before reaching the at least one switch. The coil permits retraction of the timing bar, thereby resetting the irrigation shutoff device for its next watering cycle.

On the other hand, if the sprinkler system is not functioning properly and over-watering would occur due to timer or solenoid failure, the sprinkler system is still running, thus providing water to the irrigation shutoff device. Once the timing bar reaches the at least one switch, the sprinkler system will shutoff and a malfunction indicator will show that the irrigation shutoff device was activated. The user must then reset the irrigation shutoff device.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of an irrigation shutoff device of the present invention;

FIG. 2 is a first side cut-away view of a housing portion of an irrigation shutoff device of the present invention;

FIG. 3 is a second side cut-away view of a housing portion of an irrigation shutoff device of the present invention;

FIG. 4 is a cross-sectional view along line 4-4 of the embodiment of FIG. 2;

FIG. 5 is a cut-away view of an irrigation shutoff device of the present invention installed with an electric sprinkler;

FIG. 6 is a cut-away view of an irrigation shutoff device of the present invention installed with a commercial sprinkler;

FIG. 7 is a side view of an irrigation shutoff device of the present invention installed with an irrigation valve; and

FIG. 8 is a cut-away view of an irrigation shutoff device of the present invention installed with an irrigation valve.

### DESCRIPTION OF THE PREFERRED EMBODIMENTS

For purposes of describing the preferred embodiment, the terminology used in reference to the numbered components in the drawings is as follows:
1. irrigation shutoff device, generally
2. casing
3. reset button
4. timing bar
5. timing rod
6. dial adjustment timer
7. first reservoir tube cylinder
8. second reservoir tube cylinder
9. access cover
10. propeller
11. coil
12. first switch
13. second switch
14. gear drive head
15. gasket head
16. sprinkler head
17. solenoid
18. hydraulic foot valve
19. water main line
20. foot valve adapter
21. supply line
22. system activated line
23. discharge line
24. gasket
25. malfunction indicator
26. housing
27. raised trigger
28. sprinkler casing
29. light
30. hydraulic tee
31. hydraulic pump line
32. system deactivated line
33. housing supply line
34. ground wire
35. irrigation valve housing
36. solenoid electrical wire
37. irrigation valve
38. irrigation valve pipe
39. in pressure valve
40. out pressure valve
41. warning supply line
42. pressure equalizer
43. pressure release drain
44. sprinkler
45. timing bar aperture
46. threaded exterior
47. timing rod first end
48. timing rod second end
49. plunger
50. float valve

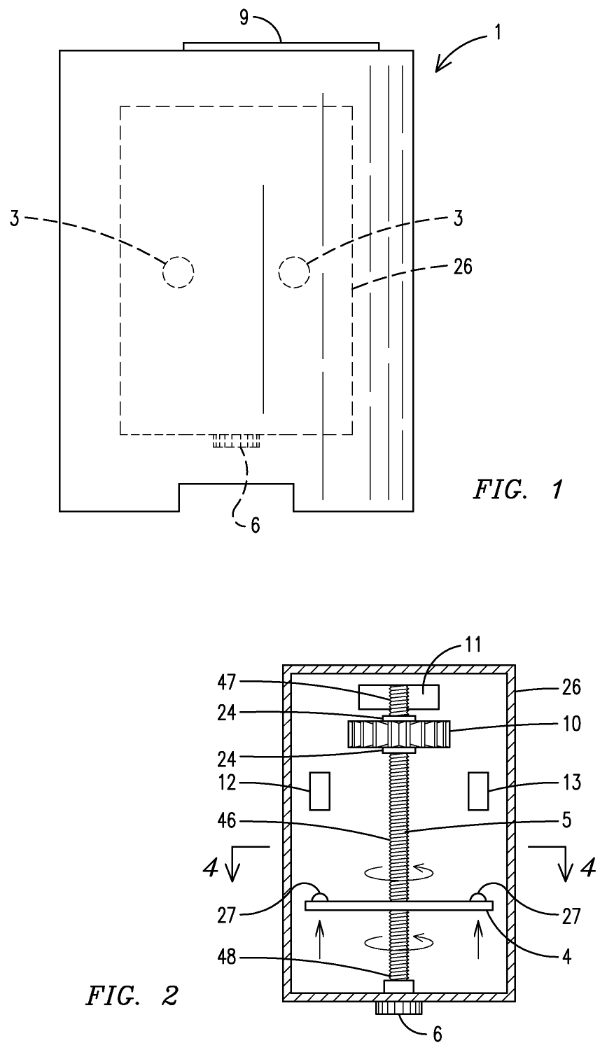

With reference to FIG. 1, a front view of an irrigation shutoff device of the present invention is shown. The irrigation shutoff device, generally 1 includes a casing 2 made of a predetermined material, preferably plastic, for placement below a ground surface. An access cover 9 is provided to permit a user to access various components of the irrigation shutoff device 1 when the device 1 must be reset or maintained. Located within the casing 2 is a housing 26 wherein most of the components of the irrigation shutoff device 1 are housed. At least one reset button 3 is located on the exterior of the housing 26 to permit a user to reset the irrigation shutoff device 1 when necessary. External to the housing 26 is a dial adjustment timer 6 that permits a user to select a predetermined time in which the irrigation shutoff device 1 will activate if required.

Next, FIG. 2 shows a first side cut-away view of a housing portion of an irrigation shutoff device of the present invention. Located within the housing 26 are the key components of the irrigation shutoff device 1, specifically, a timing rod 5, a timing bar 4, a propeller 10, a coil 11 and a first switch 12 and a second switch 13. The timing rod 5 has a threaded exterior 46, a first end 47 and a second end 48. The timing rod 5 is positioned within a center of the timing bar 4. The coil 11 and propeller 10 are secured along the timing rod 5 at a predetermined location near the timing rod first end 47 and the dial adjustment timer 6 is secured to the timing rod second end 48. Gaskets 24 are located on both ends of the propeller 10 along the timing rod 5. When the propeller 10 rotates in a clockwise manner, the timing rod 5 also rotates in a clockwise manner, thereby permitting the timing bar 4 to along the timing rod 5 to move a predetermined distance towards the first and second switches 12 and 13. The timing bar 4 preferably includes at least one raised trigger 27 thereon. When the triggers 27 hit the switches 12 and 13, which are located a predetermined distance between the timing rod first end 47 and timing rod second end 48, the irrigation shutoff device 1 ensures that water will no longer be supplied to a sprinkler.

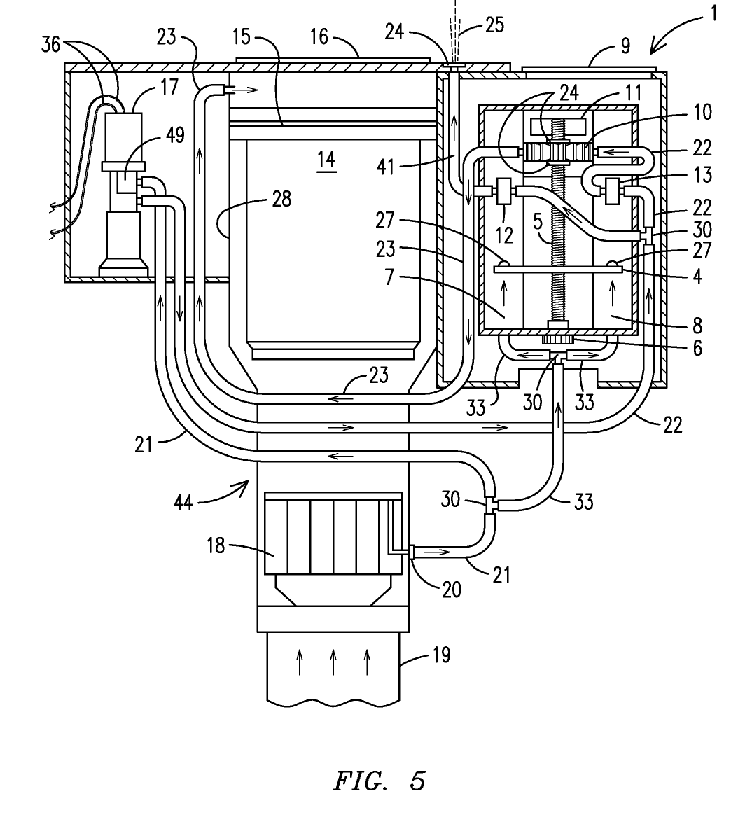

In FIG. 3, a second side cut-away view of a housing portion of an irrigation shutoff device of the present invention is shown wherein a first reservoir tube cylinder 7 and a second reservoir tube cylinder 8 are shown. The first reservoir tube cylinder 7 stores water pressure from a water main line 19 (shown in FIG. 5) to maintain a predetermined amount of water pressure through the propeller 10 (shown in FIGS. 2 and 5) and out through the discharge line 23 (shown in FIG. 5) by releasing stored water pressure for an accurate timing if water pressure in the water main line 19 drops due to a water main line 19 break or too many sprinkler heads 16 (shown in FIG. 5) turn on at the same time, thereby causing too much water flow demand and not enough water pressure.

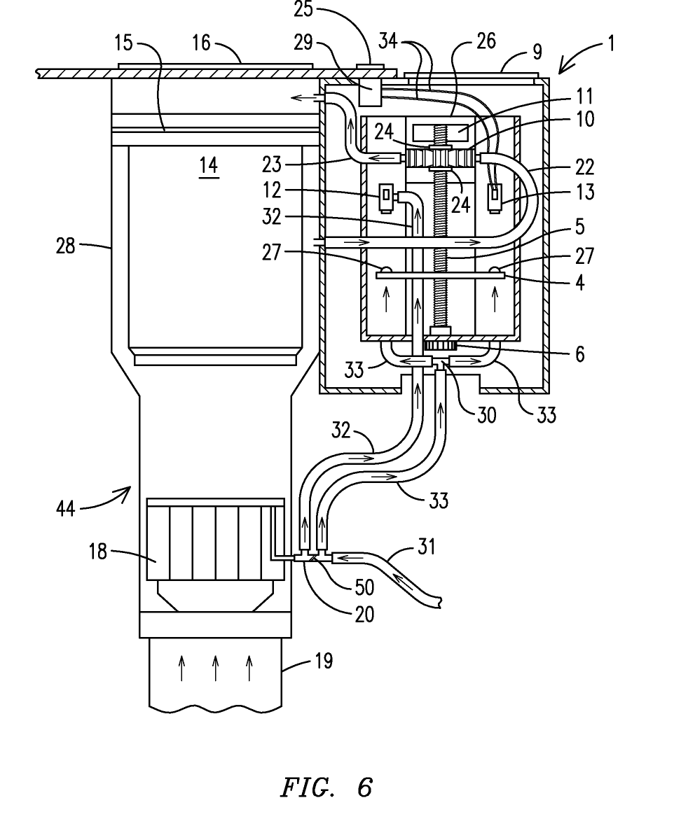

The second reservoir tube cylinder 8 stores water pressure for the system deactivated line 32 (shown in FIG. 6) and an optional manually rechargeable liquid sealant directly to turn off the hydraulic foot valve 18 (shown in FIG. 5) when activated to reinforce and seal the hydraulic foot valve 18. Preferably the reservoir tube cylinder 8 inside pressure from the water main line 19 is 45 psi whereas preferably the reservoir tube cylinder 8 inside pressure from the water main line 19 with the optional rechargeable liquid sealant is 85 psi.

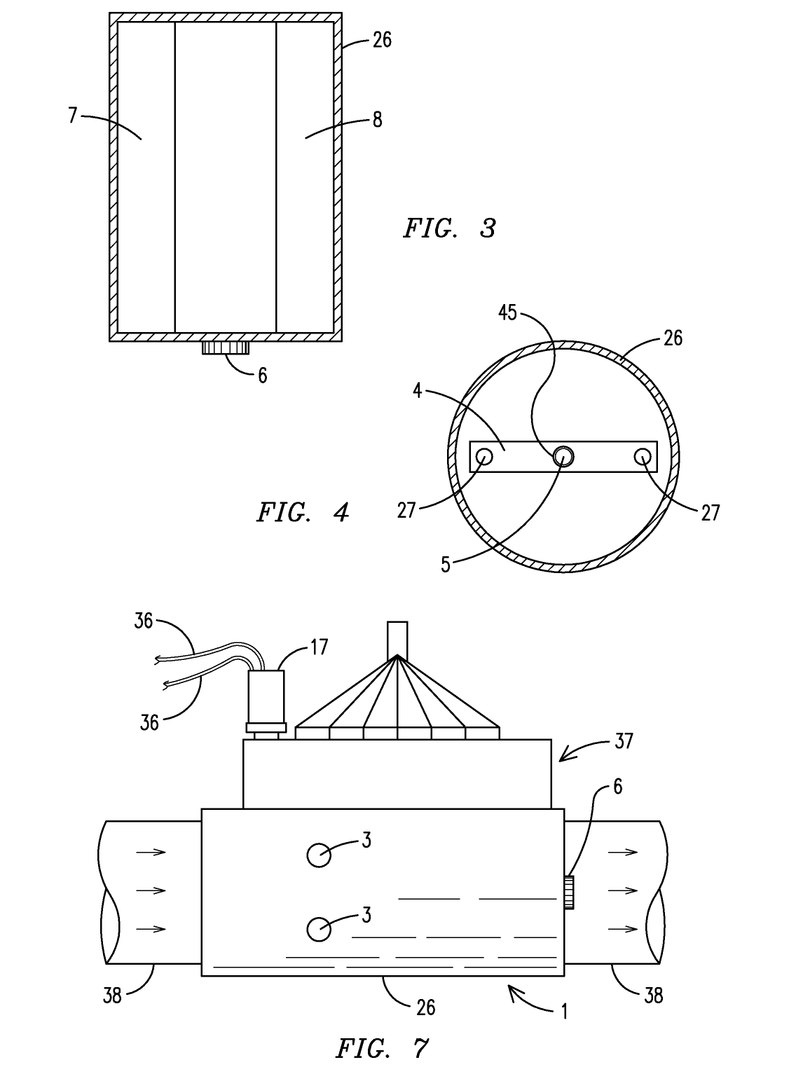

FIG. 4 shows a cross-sectional view along line 4-4 of the embodiment of FIG. 2. The timing rod 5 extends through a timing bar aperture 45 within the housing 26. In this manner, when the propeller 10 is rotated, the timing rod 5 is also rotated, thereby permitting the timing bar 4 to move in a direction towards the switches 12 and 13.

With reference to FIG. 5, a cut-away view of an irrigation shutoff device of the present invention installed with an electric sprinkler is shown. The sprinkler 44 is connected to a water main line 19 and includes a hydraulic foot valve 18, a gear drive head 14, a gasket head 15, a sprinkler head 16 and a sprinkler casing 28. In this embodiment, the sprinkler 44 is used in conjunction with a standard solenoid 17 having solenoid electrical wires 36 and a plunger 49. When using the irrigation shutoff device 1 of the present invention in conjunction with a sprinkler 44 having a solenoid 17, the solenoid 17 functions as normal.

To connect the irrigation shutoff device 1 of the present invention to a sprinkler 44, a means for connecting the irrigation shutoff device 1 to a sprinkler and a means for providing water through the propeller 10 to a sprinkler 44 are used, wherein the means are preferably various lines and adapters. First, a foot valve adapter 20 is used to connect the hydraulic foot valve 18 to a supply line 21. The supply line 21 is connected to the solenoid 17 and exits the solenoid 17 as a system activated line 22. The system activated line 22 connects through the second switch 13 and connects to the propeller 10. A discharge line 23 connects an opposite end of the propeller 10 back to the sprinkler 44. A hydraulic tee 30 is connected to the supply line 21 to provide water through a housing supply line 33 to the first reservoir tube cylinder 7 and the second reservoir tube cylinder 8. Another hydraulic tee 30 is connected to the system activated line 22 to provide water through the first switch 12, through a warning supply line 41. A user adjusts the dial adjustment timer 6 to an original start position to select a predetermined amount of time in which the sprinkler system should shutoff, hereinafter referred to as backup shutoff time. The backup shutoff time is preferably a predetermined amount of time greater than the original predetermined amount of time set using the solenoid 17 and a separate timing system (not shown), hereinafter referred to as the original time.

When the present is connected and the sprinkler system is properly functioning, meaning that the sprinkler system will turn off when the original shutoff time is reached, water flows from the water main line 19 through the supply line 21, through the system activated line 22, through the propeller 10 and out through the discharge line 23. Because water is flowing through the propeller 10, the propeller 10 rotates in a clockwise manner so as to move the timing bar 4 along the timing rod 5 closer to the switches 12 and 13. Because the original shutoff time is less than the backup shutoff time, the timing bar 4 never reaches the switches 12 and 13. Because the timing bar 4 never reached the switches 12 and 13, the coil 11 and water pressure in the reservoir tube cylinders 7 and 8 return the propeller 10 to its original position, thereby returning the timing bar 4 to its original start position.

However, if the solenoid 17 and or separate timing system are not functioning properly, such as when power outages or electrical disturbances have occurred, the sprinkler system will continue to provide water to the sprinkler 44. In this case, because the water is still being provided to the propeller 10, the timing bar 4 is still moving towards the switches 12 and 13. When the raised trigger 27 on the timing bar 4 hits the second switch 13, then water is no longer supplied through the propeller 10, thereby preventing any further water from existing through the discharge line 23 and out through the sprinkler head 16. When the raised trigger 27 on the timing bar 4 hits the first switch 12, then water is supplied from the reservoir tube cylinders 7 and 8 to permit water to exit through the warning supply line 41 and through a gasket 24 to providing a malfunction indicator 25, such as water squirting from the irrigation shutoff device 1. The malfunction indicator 25 permits a person to easily determine that there has been a malfunction in the sprinkler system. In addition, the malfunction indicator 25 informs a person that he/she must reset the irrigation shutoff device 1. When the irrigation shutoff device 1 is reset, the timing bar 4 is returned to its original starting position. In the alternative, after the irrigation shutoff device 1 has been reset, the user may readjust the backup shutoff time by manipulating the dial adjustment timer 6.

In addition, the irrigation shutoff device 1 of the present invention is capable of injecting a liquid sealant directly to the hydraulic foot valve 18 to reinforce and seal the irrigation shutoff device 1 when the timing bar 4 activates the switches 12 and 13. The irrigation shutoff device 1 is also preferably manually rechargeable after several uses.

Next, FIG. 6 shows a cut-away view of an irrigation shutoff device of the present invention installed with a commercial sprinkler. The irrigation shutoff device 1 includes the same components; however, the water lines are connected in a different manner. A foot valve adapter 20 having a float valve 50 connects the hydraulic foot valve 18 to a system deactivated line 32, a housing supply line 33 and a hydraulic pump line 31. The float valve 50 traps water pressure and sealant (if used) from the system deactivated line 32 when the triggers 27 activate the hydraulic foot valve 18, thereby not permitting deactivated water pressure to enter into an empty hydraulic pump line 31, which preferably ranges from 1 to 2,000 feet in length. When the hydraulic pump line 31 is supplying water pressure, the float valve 50 is positioned over the system deactivated line 32 and returns to a down position when the hydraulic pump line 31 is not supplying water pressure. The system deactivated line 32 connects to the first switch 12 and the second switch 13 is electrically connected via ground wires 34 to the malfunction indicator 25, which is preferably a light 29 which may be solar-powered. In addition, the system activated line 22 directly connects the sprinkler 44 to the propeller 10 and the discharge line 23 directly connects the propeller 10 to the sprinkler 44. The hydraulic pump line 31 is connected to a hydraulic pump (not shown). The hydraulic pump provides a maximum amount of water pressure to the sprinkler system through the main lines 19. Once the hydraulic pump has supplied an equal amount of water pressure in main lines 1, the hydraulic pump shuts off until a predetermined low pressure in the main lines 19 is reached at which time the hydraulic pump re-activates to raise the pressure in the main lines 19 to the desired amount. The amount of pressure in the main lines 19 drops when the sprinkler system is in use and water is being sprayed onto a ground surface. If the amount of pressure provided by the hydraulic pump is greater than that being provided through the main line 19, then the hydraulic foot valve 18 shuts off.

When the sprinkler system is properly working, water flows through the sprinkler 44 from the main line 19, through the sprinkler 44, to the propeller 10 and out through the discharge line 23 to the sprinkler 44 to water a ground surface. When the propeller 10 is rotated, the timing bar 4 moves along the timing rod 5 closer to the switches 12 and 13. If the sprinkler systems shuts off at its original shutoff time, the timing bar 4 returns to its original position until the next watering cycle.

When the original shutoff time has passed and water still continues to flow through the sprinkler 44, the timing bar 4 activates the switches 12 and 13 to stop the sprinkler head 16 from watering the ground surface and to activate the indicator malfunction 25.

In addition, the irrigation shutoff device 1 of the present invention is capable of injecting a liquid sealant directly to the hydraulic foot valve 18 to reinforce and seal the irrigation shutoff device 1 when the timing bar 4 activates the switches 12 and 13. The second reservoir tube cylinder 8 is also preferably manually rechargeable after several uses.

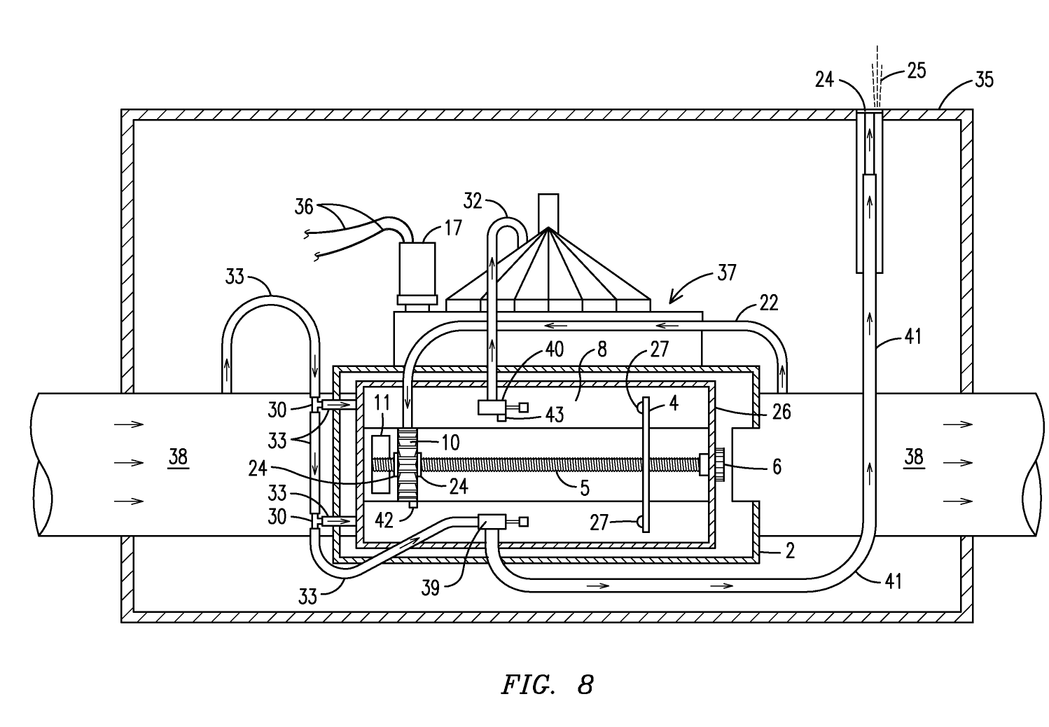

In FIG. 7, a side view of an irrigation shutoff device of the present invention installed with an irrigation valve is shown. The irrigation shutoff device 1 is connected to an irrigation valve 37 wherein the housing 26 is located external to the irrigation valve pipe 38. The irrigation valve 37 includes a solenoid 17.

Finally, FIG. 8 shows a cut-away view of an irrigation shutoff device of the present invention installed with an irrigation valve. The irrigation shutoff device 1 and irrigation valve 37 are located underground and housed in an irrigation valve housing 35. A means for connecting the irrigation shutoff device 1 to an irrigation valve 37 and a means for providing water through the propeller 10 to the irrigation valve 37 are used, wherein the means are preferably various lines and adapters. The line connections when connecting the irrigation shutoff device 1 to an irrigation valve 37 are as follows: the housing supply line 33 connects the irrigation valve pipe 38 having an incoming water flow to the reservoir tube cylinders 7 and 8 and to an in-pressure valve 39; the in-pressure valve 39 is connected to the malfunction indicator 25 by the warning supply line 41; the system deactivated line 32 connects the irrigation valve 37 to an out pressure valve 40; and the system activated line 22 connects the outgoing water flow from the irrigation pipe 38 to the propeller 10. A pressure equalizer 42 is located on the propeller and a pressure release drain 43 is located on the out pressure valve 40.

When the sprinkler system is properly operating, water flows from the main line 19 through the irrigation valve pipe 38 of the irrigation valve 37. Water flows through the irrigation valve housing 35 and into the housing 26. Outgoing water from the irrigation valve pipe 38 flows into the propeller 10 via the system activated line 22 to rotate the propeller 10, thereby permitting the timing bar 4 to move closer to the in pressure valve 39 and out pressure valve 43. If the water flow turns off at the original shutoff time, then the coil 11 retracts the timing bar 4 to return to its original start position.

If the sprinkler system is on for an amount greater than the original shutoff time, then the raised triggers 27 on the timing bar 4 will hit the in pressure valve 39 and out pressure valve 40. When a raised trigger 27 hits the in pressure valve 39, water flows through the warning supply line 41 and exits through the irrigation valve housing 35 as an indicator malfunction 25. When a raised trigger 27 hits the out pressure valve 40, water flows through the system deactivated line 32 to turn off the irrigation valve 37, thereby preventing over-watering of a ground surface.

In addition, the irrigation shutoff device 1 of the present invention is capable of injecting a liquid sealant directly to the hydraulic foot valve 18 to reinforce and seal the irrigation shutoff device 1 when the timing bar 4 activates the switches 12 and 13. The irrigation shutoff device 1 is also manually rechargeable after several uses.

The use of the present invention will prevent over-watering of a ground surface in the event a sprinkler system continues to operate after surpassing an original shutoff time.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. An irrigation shutoff device comprising:
a timing bar having an aperture located therein;
a timing rod having a first end and a second end;
said timing rod having a threaded exterior;
said timing rod extending through said timing bar aperture;
a propeller secured to said timing rod first end wherein said propeller rotates said timing bar a predetermined distance on said timing rod when water is provided through said propeller;
a coil secured to said propeller;
a dial adjustment timer secured to said timing rod second end;
a means for connecting said irrigation shutoff device to a sprinkler;
a means for providing water through said propeller to a sprinkler; and
at least one switch located a predetermined distance between said timing rod first end and said timing rod second end wherein when said timing bar hits said at least one switch, water is no longer provided to a sprinkler.

2. The irrigation shutoff device of claim 1 further comprising:
a means for indicating a malfunction has occurred.

3. The irrigation shutoff device of claim 1 further comprising:
a means for resetting said irrigation shutoff device.

4. The irrigation shutoff device of claim 3 wherein:
said means is at least one reset button.

5. The irrigation shutoff device of claim 2 further comprising:
a means for resetting said irrigation shutoff device.

6. The irrigation shutoff device of claim 5 wherein:
said means is at least one reset button.

7. The irrigation shutoff device of claim 1 further comprising:
a means for connecting said irrigation shutoff device to a solenoid.

8. The irrigation shutoff device of claim 2 further comprising:
a means for connecting said irrigation shutoff device to a solenoid.

9. The irrigation shutoff device of claim 1 further comprising:
a first reservoir tube cylinder; and
a second reservoir tube cylinder.

10. The irrigation shutoff device of claim 1 wherein:
said means for connecting said irrigation shutoff device to a sprinkler is a system activated line.

11. The irrigation shutoff device of claim 1 wherein:
said means for providing water to a sprinkler is a discharge line.

12. The irrigation shutoff device of claim 10 wherein:
said means for providing water to a sprinkler is a discharge line.

13. An irrigation shutoff device comprising:
a timing bar having an aperture located therein;
a timing rod having a first end and a second end;
said timing rod having a threaded exterior;
said timing rod extending through said timing bar aperture;
a propeller secured to said timing rod first end wherein said propeller rotates said timing bar a predetermined distance on said timing rod when water is provided through said propeller;
a coil secured to said propeller;
a dial adjustment timer secured to said timing rod second end;
a means for connecting said irrigation shutoff device to an irrigation valve;
a means for providing water through said propeller; and
at least one pressure valve located a predetermined distance between said timing rod first end and said timing rod second end wherein when said timing bar hits said at least one pressure valve, water is no longer provided to said irrigation valve.

14. The irrigation shutoff device of claim 13 further comprising:
a means for indicating a malfunction has occurred.

15. The irrigation shutoff device of claim 13 further comprising:
a means for resetting said irrigation shutoff device.

16. The irrigation shutoff device of claim 15 wherein:
said means is at least one reset button.

17. The irrigation shutoff device of claim 14 further comprising:
a means for resetting said irrigation shutoff device.

18. The irrigation shutoff device of claim 17 wherein:
said means is at least one reset button.

19. The irrigation shutoff device of claim 13 further comprising:
a first reservoir tube cylinder; and
a second reservoir tube cylinder.

20. The irrigation shutoff device of claim 13 wherein:
said means for connecting said irrigation shutoff device to said irrigation valve is a system activated line.

21. The irrigation shutoff device of claim 1 wherein:
said means for providing water to said irrigation valve is a system deactivated line.

22. The irrigation shutoff device of claim 13 wherein:
said means for providing water through said propeller is a system activated line.
